(19) United States
(12) Patent Application Publication
(10) Pub. No.: US 2002/0161639 A1
(43) Pub. Date: Oct. 31, 2002

(54) Method and apparatus for targeted advertising and promotions using a computer network

(76) Inventor: Michael Goldstein, West Palm Beach, FL (US)

Correspondence Address: Frank A. Cona, Schnader Harrison Segal & Lewis, LLP, Suite 3600, 1600 Market Street, Philadelphia, PA, 19103, US

(21) Appl. No.: 10/095,754

(22) Filed: Mar. 11, 2002

Related U.S. Application Data
(60) Provisional application No. 60/274,511, filed on Mar. 9, 2001.

(51) Int. Cl. G06F 17/60

(52) U.S. Cl. 705/14; 705/26

(57) ABSTRACT

The present invention is directed to a system for conducting targeted advertising and promotions from at least one seller selected from a plurality of sellers to at least one buyer selected from a plurality of buyers using a computer network. The system includes receiving seller information, including seller identifying information and seller preference information, over the computer network; receiving buyer information, including buyer identifying information and buyer preference information over the computer network; selecting at least one seller from the plurality of sellers and at least one buyer from the plurality of buyers based upon the buyer preference information and the seller preference information; incorporating seller identifying information for the selected seller into a buyer game piece for a game to be provided to the buyer over the computer network using the buyer information to determine a winner of the game from among the plurality of buyers; and tracking the buyer and the seller's actions in connection with the game.

### CROSS-REFERENCE TO RELATED APPLICATION

This application claims the benefit, under 35 U.S.C. §120, of U.S. Provisional Patent Application Serial No. 60/274,511, now abandoned.

### STATEMENT REGARDING FEDERALLY SPONSORED RESEARCH

Not applicable.

### REFERENCE TO MICROFICHE APPENDIX

Not applicable.

### BACKGROUND OF THE INVENTION

1. Field of the Invention

The present invention relates to a system for targeted advertising and promotions using a computer network.

2. Description of the Prior Art

Conventional systems exist in the prior art that allow for the marketing of goods and services to individuals over a computer network, using an incentive award program. For example, U.S. Pat. No. 5,983,196 to Wendkos discloses a computer implemented system to award promotional incentives. In this conventional system, a participant connects to an interactive platform for registering or redeeming credits described in unique certificates.

However, conventional systems for conducting promotional events using a computer network do not allow for the targeted, ongoing marketing of the goods and service of one or more seller, such as an event sponsor or an advertiser, to a specific type of buyer. Accordingly, a system is needed in which sellers can target market to consumers using designated selection criteria, which are used to select at least one buyer from a plurality of buyers who have submitted their own preference information.

### SUMMARY OF THE INVENTION

The present invention is directed to a system for conducting targeted advertising and promotions from at least one seller selected from a plurality of sellers to at least one buyer selected from a plurality of buyers using a computer network. The system includes receiving seller information, including seller identifying information and seller preference information, over the computer network; receiving buyer information, including buyer identifying information and buyer preference information over the computer network; selecting at least one seller from the plurality of sellers and at least one buyer from the plurality of buyers based upon the buyer preference information and the seller preference information; incorporating seller identifying information for the selected seller into a buyer game piece for a game to be provided to the buyer over the computer network using the buyer information to determine a winner of the game from among the plurality of buyers; and tracking the buyer and the seller's actions in connection with the game.

### BRIEF DESCRIPTION OF THE DRAWINGS

FIG. 1 is a block diagram illustrating a preferred embodiment of the present invention used over a communication network, such as the Internet.

FIGS. 2(a)-(c) are block diagrams illustrating the elements of the preferred embodiment incorporated in the information exchange system of the present invention.

FIGS. 3(a)-(c) are flow charts illustrating operation of the preferred embodiment of the present invention by a user.

FIG. 4 is an illustration of a targeted email game piece of a preferred embodiment of the present invention.

FIG. 5 is an illustration of a Web site banner game piece of a preferred embodiment of the present invention.

FIG. 6 is an illustration of a scratch card game piece of a preferred embodiment of the present invention.

FIG. 7 is an illustration of a magazine insert game piece of a preferred embodiment of the present invention.

### DETAILED DESCRIPTION OF THE PREFERRED EMBODIMENT

The present invention will be understood more fully from the detailed description given below and from the accompanying drawings of preferred embodiments of the invention which, however, should not be taken to limit the invention to a specific embodiment but are for explanation and understanding only.

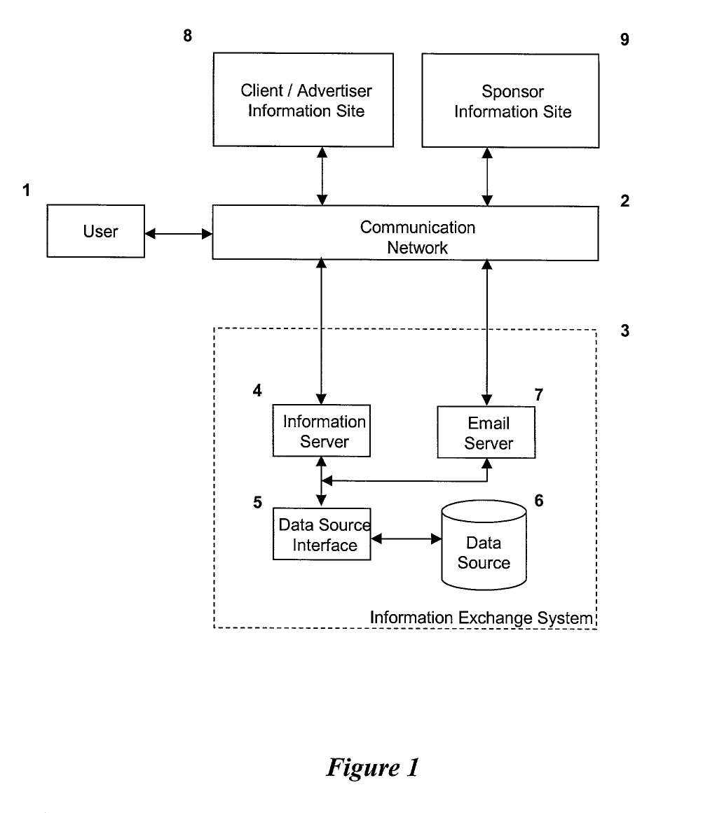

FIG. 1 is a schematic demonstrating the typical components used in a preferred embodiment of the invention when used over a computer network, such as the Internet. Those of ordinary skill in the art will appreciate that the present invention, while described below in connection with its use over the Internet, is certainly not limited thereto.

The terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, a digital watch and the like. Further, a computer, computer system, or system of the invention may operate in communication with other systems over a communication network, such as, for example, the Internet, an intranet, or an extranet, or may operate as a stand-alone system.

The invention may be implemented through the use of a computer network, such as the Internet, and more particularly, the World Wide Web (the “Web”). While the invention disclosed herein depicts a preferred embodiment of the invention as deployed over the Internet using a Web browser, those of ordinary skill in the art will appreciate that the invention is not limited thereto and may be deployed using other means computer-based or otherwise, such as for example, thin client applications, and may be deployed over a closed network, Virtual Private Network, and any other securable internetworked system.

The Web allows users to interact with each other and access content through a graphical user interface, or “GUI.” The most commonly used GUI's are Web browsers, which are software applications that allow users to access and view electronic documents in a browser window. Web documents are created using Hypertext Markup Language (“HTML”), which allows authors to add special format tags to plain text documents to control the appearance of the text in the Web browser. HTML tags also allow for the insertion of additional components into the Web document, such as image files, audio files, and applets. Applets are small pieces of programming code that are run on the user's computer when downloaded. Applets allow for such effects as scrolling text and animation, and for use in the secure transfer of information across the Internet. To enhance security, an information server may use Secure Socket Layer (“SSL”) technology, which is widely known by those skilled in the art and is integrated into most commercially acceptable web browsers. One of ordinary skill in the art will appreciate that other, similar technology is also capable of being used in the present invention, such as, for example, Visual Basic, Java/Java script, Active Server Pages (“ASP”), extensible Markup Language (“XML”), and Simple Object Access Protocol (“SOAP”).

In sum, this embodiment of the invention includes User 1, who typically uses a document viewer and a personal computer to access Communication Network 2 in a conventional manner, which allows user to access the system of the present invention. By using Communication Network 2, User 1 may contact Information Exchange System 3, Client/Advertiser Information Site 8 and Sponsor Information Site 9. Client/Advertiser Information Site 8 and Sponsor Information Site 9 are typically Internet Web sites, although not limited thereto. The regular operation of such sites is well known to those of ordinary skill in the art and will not be elaborated upon here, except as in conjunction with the operation of Information Exchange System 3.

User 1 will communicate with Advertiser Site 8 and Sponsor Site 9 in conjunction with the use of Information Exchange System 3, as described in more detail below. Information Exchange System 3, preferably includes at least an Internet Web Server 4, a Data Source Interface 5, a Data Source 6, and an Email Server 7.

To input and extract information from Information Exchange System 3, an electronic document, such as a Web page created using HTML, is loaded by User 1 into the user's document viewer. The document viewer may be any software application capable of viewing electronic documents and loading additional electronic documents from within the original document, such as through the use of a hypertext link or form (although not limited thereto). For example, the document viewer could include a Web browser, such as Navigator from Netscape Communications or Microsoft's Internet Explorer. The electronic document may be loaded automatically when the document viewer is first started, or may be opened into the viewer by the user from a file stored locally or at a remote address. For example, the user may load the document by typing the document's address into the Web browser's command line.

The document viewer may be accessed by the user through any of a number of computer systems, such as through the use of a terminal connected to a mainframe system, from a personal computer, or over a computer connected to a local computer network.

The document viewer is connected to Communication Network 2 through a local network connection (not shown). This connection is typically made through local telephone lines using an analog, ISDN, or DSL connection, though it can be over a direct network connection, such as an Ethernet network and leased line. In the preferred embodiment, the network connection may be a computer network that routes any requests from the document viewer to the appropriate location on the Internet. This operation is well known to those of skill in the art. Communication Network 2 connects the document viewer of User 1 to Web Server 4 in Information Exchange System 3 through any of a number of well-known connection schemes, such as through the use of leased lines.

Web Server 4 is typically a software application running on a computer that is capable of forwarding or processing requests from the document viewer. For example, Web Server 4 may include any one of a number of well-known server applications, such as the NSCA Web server, the Apache Web server, etc. Web Server 4 passes a document request from the document viewer to Data Source Interface 5 for accessing Data Source 6. Data Source 6 contains all of the information provided by each of User 1, Advertiser Site 8, and Sponsor Site 9, as described in more detail below.

After a document, such as an HTML form (or series of forms), is loaded into the document viewer, the user enters in the appropriate information and activates a hypertext link or form “Submit” button, generating a signal back to Data Source Interface 5. This is preferably in the form of an HTTP request sent over the Internet using TCP/IP and possibly a Secure Socket Layer (“SSL”). The request may be routed through Communication Network 2 and through Web Server 4 to Data Source Interface 5. It will be appreciated that the details of HTTP operation in conjunction with TCP/IP and SSL are well known to those of ordinary skill in the art and will, therefore, not be elaborated on here. Alternatively, instead of an HTML form, an email may be sent by document viewer one using any number of well-known communication protocols, such as the Simple Mail Transfer Protocol (SMTP).

When the HTTP request is received by Data Source Interface 5, it accesses Data Source 6 to retrieve the requested information based upon the signal from the document viewer. In one embodiment of the invention, a common gateway interface (“CGI”) program, well known to those of skill in the art, may be used to parse the data from the Document Viewer. This program acts as an interface between the Web Server 4 and/or Data Interface 5 and Data Source 6 by executing a set of instructions. The interaction of Web servers and CGI programs and the sending of information therebetween is well known to those of ordinary skill in the art. The CGI program can take a number of forms which are well known in the art, such as PERL scripting, C++ modules, Visual Basic or other common programming languages. It may also comprise, for example, an Application Program Interface (“API”) or a suite of database tools or objects associated with Data Source 16.

The CGI program may extract the document information from the information passed to it by the server and retrieve the appropriate information from Data Source 6. This may be accomplished in a number of ways known to those of ordinary skill in the art. For example, if the CGI program is a PERL script or other API, a database access module can be used to interface with the majority of commercial relational database applications. Examples of such databases include Oracle, Sybase, SQL Server, and the like. It is also possible for these systems to be accessed directly by Web Server 4 using their own internal data engines.

Information is submitted to or extracted from Data Source 6, depending on the signal sent by the Document Viewer. Data Source Interface 5 then generates a signal back to the Document Viewer through Web Server 4. Email Server 7 is also used to communicate with User 1, as will be described in more detail below.

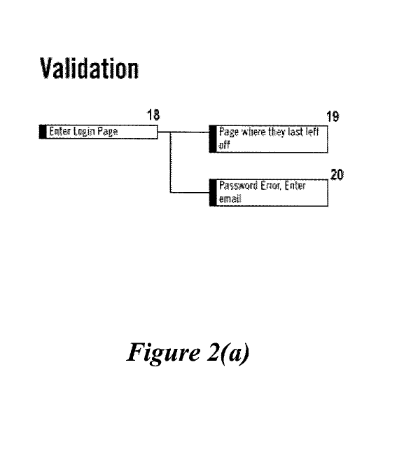

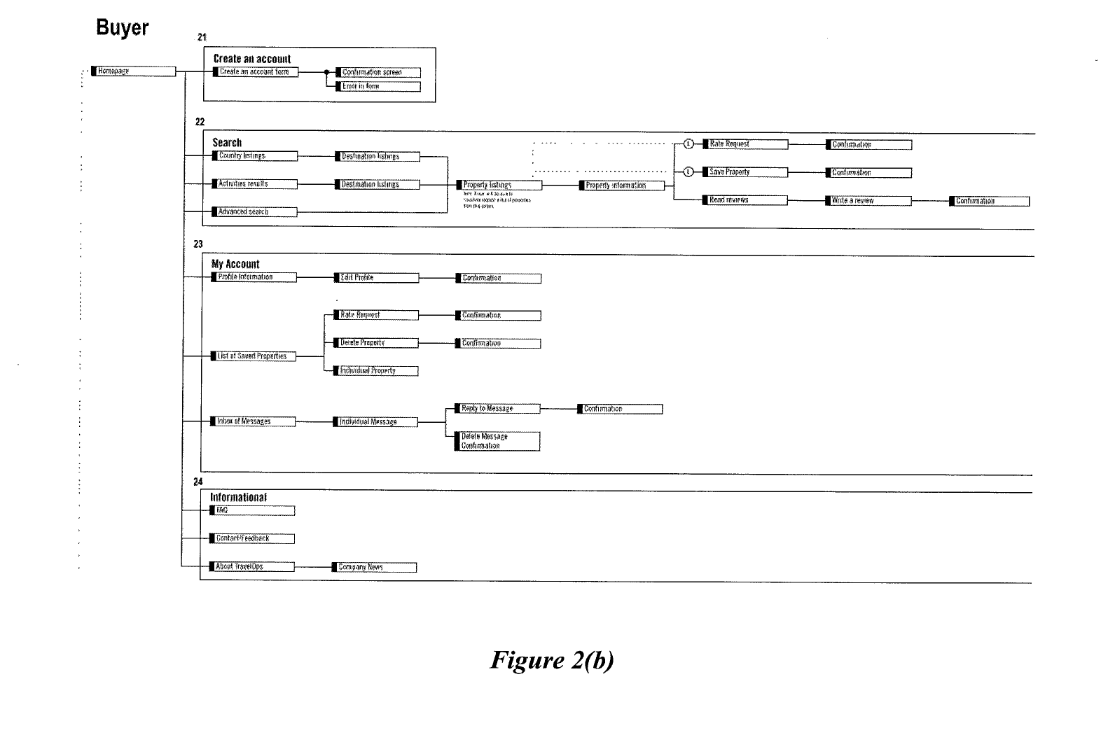

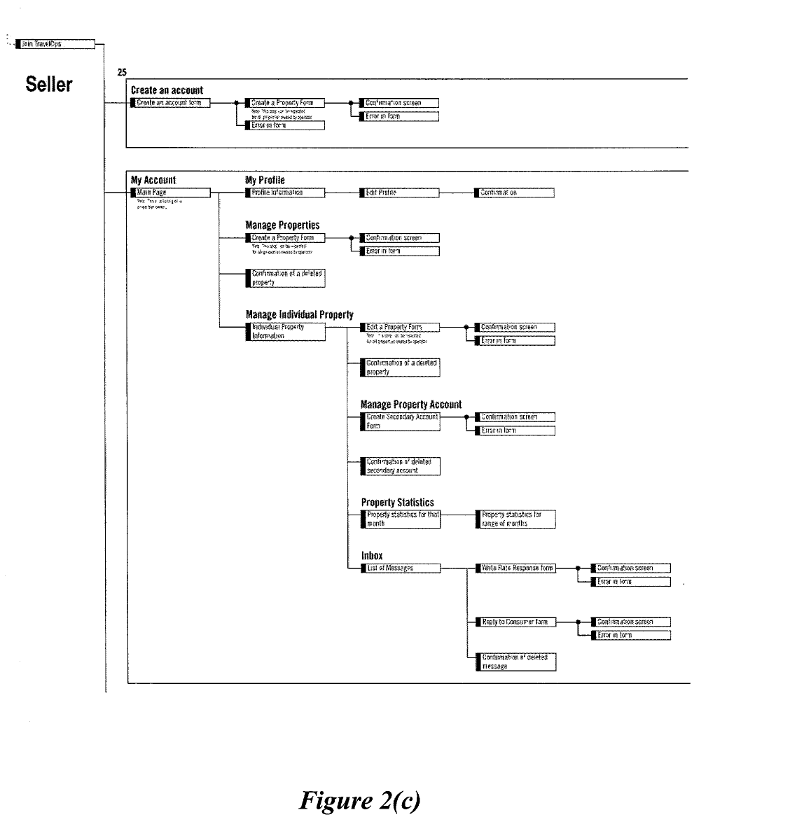

FIGS. 2(a)-(c) more particularly illustrate the components embodied in Web Server 4, Data Source Interface 5, Data Source 6, and Email Server 7. These components preferably include Validation, User Profile, and Customer Service, where these terms are used for identification purposes and are not meant to limit the scope of the invention in any way. It will be appreciated by those of skill in the art, however, that the system of the present invention is not specifically limited thereto, and can be used in connection with many types of products and services, such as consumer products and the like.

As shown in FIG. 2(a), the Validation component is used to allow users to log into Information Exchange System 3. This may be accomplished using Login Page 18, which may comprise a Web page generated by Web Server 4, Data Interface 5, and Data Source 6, as previously described. This Web page (and all Web pages hereinafter described) may be generated in a variety of forms well known to those of skill in the art, such as dynamic HTML, XML, or ASP (Active Server Pages), although not limited thereto. Login Page 18 may return Last Page Visited 19 (if the user name and password are validated), or Error Page 20 (if the user does is not validated).

As Shown in FIG. 2(b), the User Profile component may include Account Creator 21, Profiler 23 and Information System 24. Account Creator 21 allows Users to create an account (preferably a free account, without the need for providing credit card or payment related information) with Information Exchange System 3, through which they can establish and modify their user profile using Profiler 23. By establishing a user account, users can store all of their preferences for their user profile, such as what types of properties (e.g. resorts, consumer goods, services, etc.) they would like to receive information about. The present invention provides the significant advantage that users only receive information about properties that they have agreed to receive, and thus are not subjected to unsolicited information. These preferences are stored in Data Source 6 by Data Source Interface 5 in a conventional manner.

Information System 24 provides the User 1 with feedback and information relating to Information Exchange System 3, such as Frequently Asked Questions (FAQ's) about the system, contacting the operators of the system, news updates, etc.

As shown in FIG. 2(c), the Customer Service component may include Account Locator 31, Account Creator 32, and Inbox 33. Account Locator 31 allows administrators of Information Exchange System 3 to review and maintain user accounts, compile user statistics, etc. Account Creator 32 allows the administrators to create additional accounts or to modify the parameters of existing accounts and user profiles. For example, if Data Source Interface 5, and Data Source 6 comprise a relational database system, Account Creator 32 would allow administrators to modify the database schema using the conventional tools associated therewith. Inbox 33 allows the administrators to communicate with User 1, preferably by email, as previously described.

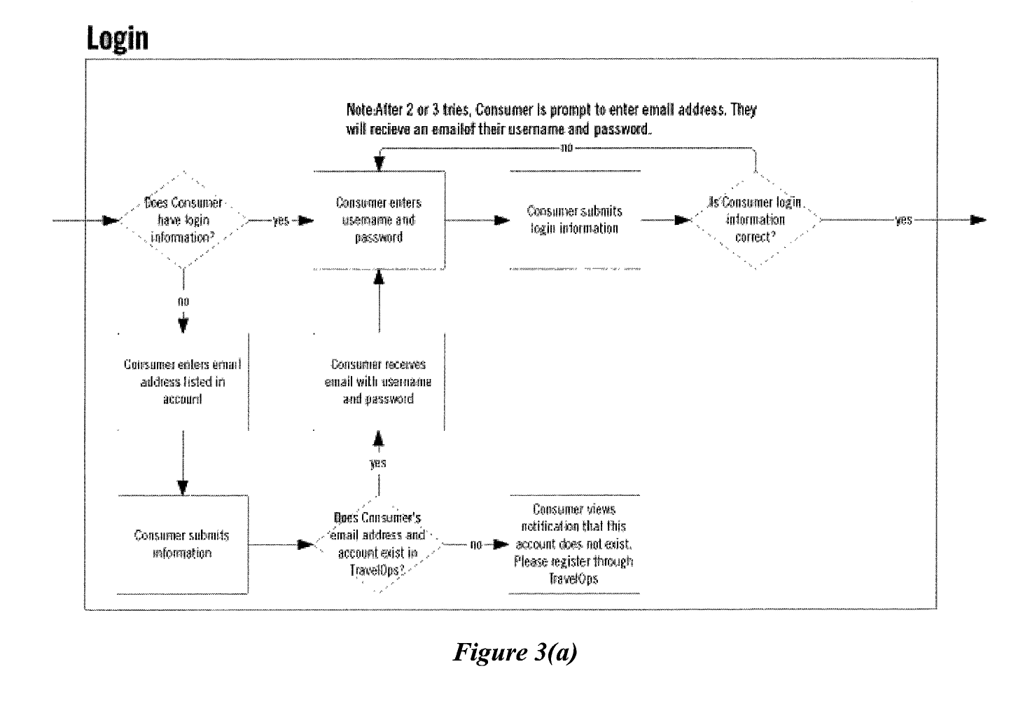

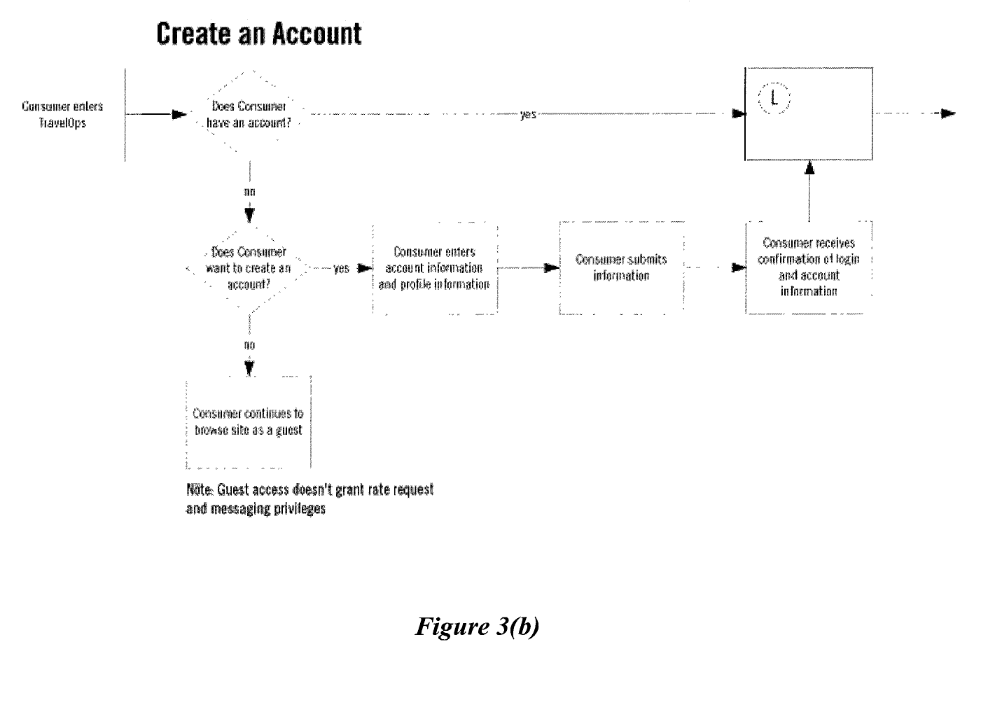

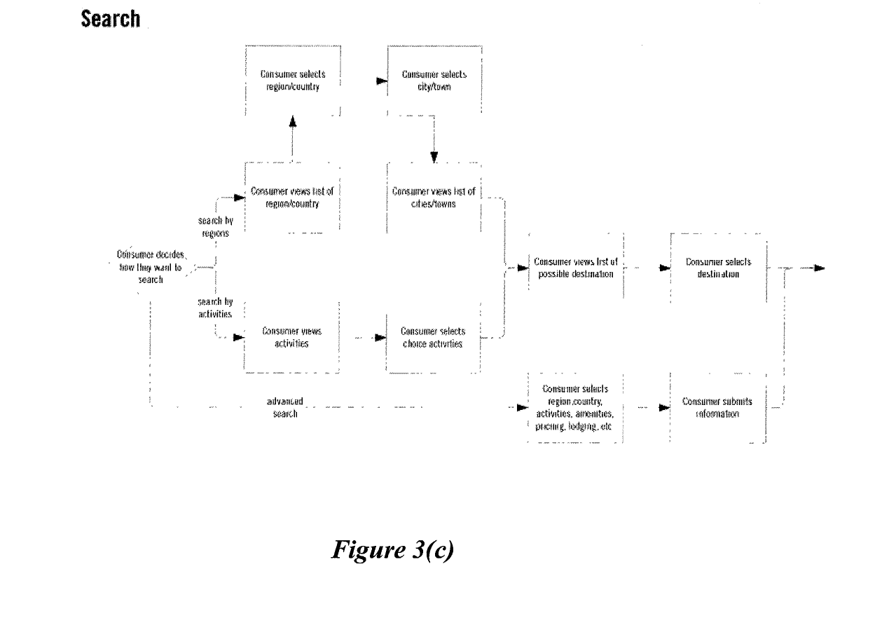

The specific operation of the system, when used in the travel industry, is illustrated in detail in FIGS. 3-8. As shown in FIG. 3(a), when a user wishes to log into the system, the user is queried by Information Exchange System 3 as to whether or not the user already has an account (including a user name and password) stored in Information Exchange System 3. This may be accomplished in any number of conventional manners, such as through the use of HTML forms, or a “cookie” file stored on the user's computer—both of which are well known to those of skill in the art. If the user has the login information, then this information is entered and submitted to Information Exchange System 3, verified, and, if approved, the user is given access to the system.

If the user does not have the proper login information, then the user may be prompted to submit identifying information, such as an email address, which is checked against Data Source 6 in a conventional manner. If this identifying information exists, then the user may be sent a copy of the user name and password, preferably via email at the email address submitted. If the email address does not exist, then the user may be notified that the account does not exist and that one should be created.

The creation of a new account is illustrated in FIG. 3(b). The user enters the Web site (e.g. Information Exchange Server 3), which prompts the user as whether the user has an existing account, if yes, then the user can log in, as previously described. If no, then the user is prompted as to whether the user wishes to create an account. To create an account, the user submits requested identifying information, such as name, email, travel preferences, etc. This information may be used to create an account profile. A significant advantage of the present invention is the use of this profile information is to customize any searches and submissions conducted by the user.

Users may edit their profiles as shown in FIG. 3(c). Users may edit both their account information and profile information. This may be accomplished through many means well known to those of skill in the art, such as through the use of HTML forms and database, as previously described.

Once User 1 has created his profile and entered his preferences, Information Exchange System 3 may then periodically generate an electronic message or newsletter concerning the properties designated by User 1. The information about these properties may be periodically generated by Advertiser Site 8 and/or Sponsor Site 9, and automatically stored in Data Source 6 through Data Source Interface 5 using the aforementioned systems, or may be manually entered by the administrator of Information Exchange System 3.

The electronic message is preferably sent to User 1 as an email message. In the preferred embodiment of the invention a game piece is also included in the electronic message. The game piece provides User 1 the opportunity to win any prize stored or designated in Information Exchange System 3, as donated by the Sponsor, which is preferably a property of the type the User indicated in his profile preferences. For example, if the user selected his preferences to indicated that he wished to receive information about travel, resorts, cruises, and the like, he may receive information in his electronic newsletter about vacation destinations, travel articles, airfares, etc., and may receive a game piece in which the prize is a week at Sponsor's resort. The game piece may also contain promotions from the Advertiser, which may be the same organization as the Sponsor of the game, or may be another. For example, the prize in the aforementioned game piece may be a week at Sponsor's resort, and the newsletter may contain advertisements for rental car agencies, airlines, etc.

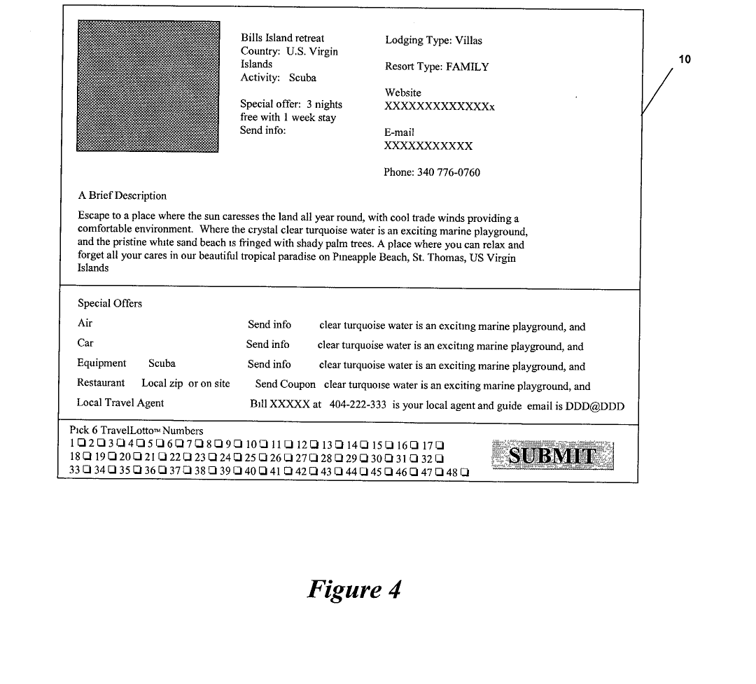

A preferred embodiment of the email game piece is shown in FIG. 4. As can be seen in FIG. 4, Email Game Piece 10 may contain information about the prize from the Sponsor (in this example a vacation trip), promotional offers from the Advertisers, and a game piece, such as the “Pick 6” lottery shown as an example. Of course, it will be appreciated to those of ordinary skill in the art that the game employed in the game piece can be any number of games, and is not particularly limited.

In this particular embodiment, User 1 would select six numbers on the enclosed HTML form, and click the submit button to send the information back to Information Exchange System 3.

Alternatively, User 1 may place these numbers in an email to the reply address designated in the email game piece, and send the reply. The reply would then be transmitted from User 1 to Email server 7 in Information Exchange System 3, and would be stored in Data Source 6.

After receiving the selections from User 1, Information Exchange System 3 would then periodically review all of the submitted reply messages and compare the selected numbers against the winning numbers (preferably previously stored in Data Source 6). All of this may be accomplished using conventional CGI programs, which will not be elaborated upon here. Information Exchange System 3 would then designate the winner, who may be notified by return email. Alternatively, User 1 may use the document viewer to retrieve the winning numbers from Information Exchange System 3. For example, User 1 may access Web Server 4 to retrieve a Web page form. The user would then enter a pre-selected promotion number that he had received with the game piece and submit the request. Information Exchange System 3 would then return the details of the promotion: the winning numbers, number of participants, etc. to the user.

Alternatively, User 1 may be required to visit Advertiser Site 8 or Sponsor Site 9 to obtain the promotion information in a similar manner. This information may be integrated, for example, into an HTML Web page on Advertiser Site 8 or Sponsor Site 9 that is fed, in a conventional manner from Information Exchange System 3. User 1, when visiting Advertiser Site 8 or Sponsor Site 9 might be required to activate a link on those sites, which would provide tracking information about User 1 back to Information Exchange System 3, allowing Information Exchange 3 to directly track the success of the marketing campaign. Such a link may be created using many well-known and existing software systems, such as those built upon Java, Java Applets, Java Script, cookies, and the like.

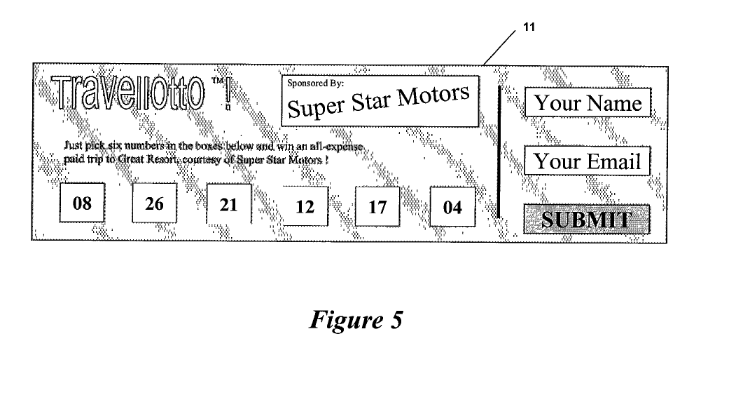

Another preferred embodiment of the game piece of the present invention is shown in FIG. 5. Similarly to Email Game Piece 10, Web Page Banner Game Piece 11 may allow users to, for example, play a “Pick 6” lottery. These may be accomplished through the aforementioned use of Java applets and the like. User 1 loads a Web page containing the banner into the document viewer, and would then enter his name and email address, or the user name and password for his user profile, or some other identifier, and would activate the banner, submitting the information to Information Exchange System 3. The banner may, of course, be located on any number of Web sites, including Information Exchange System 3, Advertiser Site 8, and Sponsor Site 9.

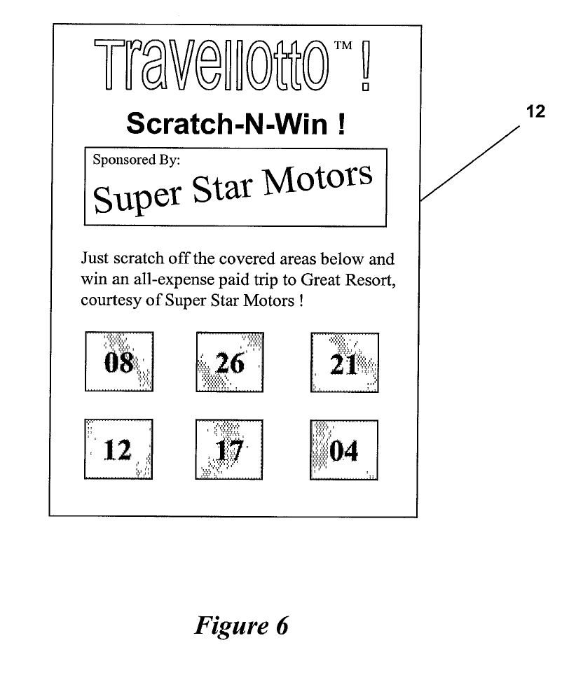

A further embodiment of the game piece of the present invention is shown in FIG. 6. Each Scratch Card Game Piece 12 may include a game, such as the aforementioned “Pick 6” lottery, which includes six randomly generated numbers under the covered surface. Once User 1 scratches off the surface cover to reveal the numbers, User 1 may then access Information Exchange System 3, Advertiser Site 8, and/or Sponsor Site 9 in the above-described manner to determine if he is a winner.

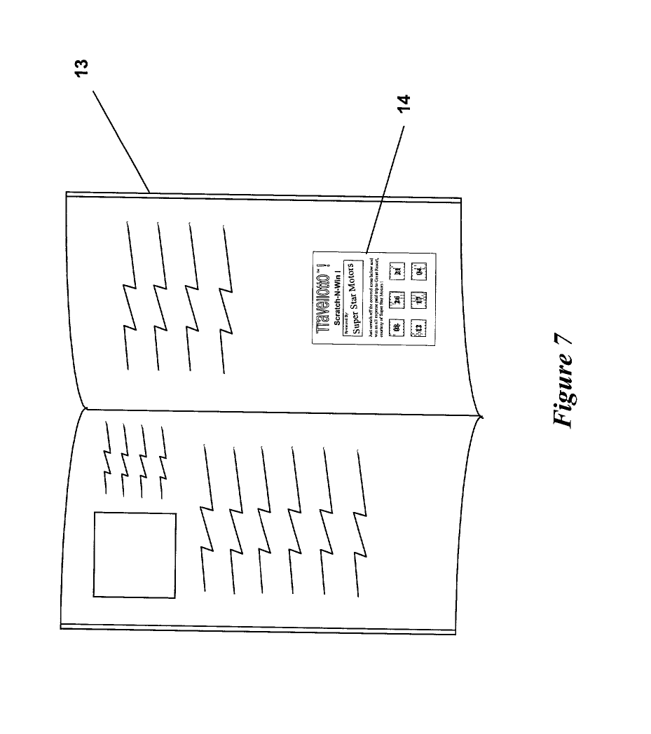

Another preferred embodiment of the game piece is shown in FIG. 7. In this preferred embodiment, the Scratch Card Game Piece is included as an insert in a magazine, or even as part of the printed page. As with the stand-alone scratch card, User 1 may play the game offline, but venture online to determine if he is a winner. Again, User 1's activities can be tracked by information Exchange System 3, and in a non-obtrusive manner.

A further preferred embodiment of a game piece of the present invention may be played over a cellular phone. The game piece would be downloaded and displayed, for example, when User 1 activates the cellular phone to retrieve text messages and other information, such as email and the like. The results of the game may then be sent back to Information Exchange System 3 through the provider of the cellular service's network through a gateway to the Internet in a conventional manner.

Finally, a preferred embodiment of a game piece of the present invention played from the desktop of the personal computer operated by User 1 to access Information Exchange Server 3 through Communication Network 2. A graphic icon, may be installed on the desktop of the personal computer to be used in a conventional manner to launch a resident software application that access Information Exchange System 3 to download the electronic message or newsletter for User 1, and the designated game piece. Thereafter, User 1 may play the game in the manner previously described.

Alternatively, the resident software application may run continuously in the background on the personal computer, accessing Information Exchange System 3 on a periodic basis to automatically download and display the electronic newsletter. Moreover, standard push technology and similar communication systems may be employed to update the resident software application and download the newsletter. The resident software application itself may, of course, be coded and compiled from any number of platforms, such as Java, C++, and the like, well known to those of ordinary skill in the art.

The use of a game piece in the manner of the present invention provides an incentive for User 1 to create a user profile on Information Exchange System 3, thereby allowing for targeted marketing of properties from the Advertisers and Sponsors to User 1, and only properties of the type that User 1 wishes to receive. Thus, the present invention provides the significant advantage over the electronic mass mailing systems of the prior art that only the target customer is impacted, and the success of the marketing campaign can be tracked directly.

Although this invention has been described with reference to particular embodiments, it will be appreciated that many variations may be resorted to without departing from the spirit and scope of this invention. For example, the user interface, data source interface, and data source of the present invention may comprise a single software application, and may be operated from a single computer or a network of computers via the Internet or an internal intranet. Moreover, for example, a network of personal computers may be used, a mainframe system, or a server and peripheral thin clients. Also, the particular game played and the market targeted are not particularly limited only to those disclosed herein, but may include any game and target market to which the invention may be applied.

What is claimed is:

1. A method for conducting targeted advertising and promotions from at least one seller selected from a plurality of sellers to at least one buyer selected from a plurality of buyers using a computer network, said method comprising the steps of:
receiving seller information, said seller information including seller identifying information and seller preference information over said computer network;
receiving buyer information, said buyer information including buyer identifying information and buyer preference information over said computer network;
selecting at least one seller from said plurality of sellers and at least one buyer from said plurality of buyers based upon said buyer preference information and said seller preference information;
incorporating seller identifying information for said selected seller into a buyer game piece for a game to be provided to said buyer over said computer network using said buyer information to determine a winner of said game from among said plurality of buyers; and
tracking said buyer and said seller's actions in connection with said game.
